(19) United States
(12) Patent Application Publication
(10) Pub. No.: US 2022/0370941 A1
(43) Pub. Date: Nov. 24, 2022

(54) HYDRO-ENHANCED AIR CLEANER AND POTABLE WATER SUPPLY SYSTEM

(71) Applicant: Mark Applegate, Lanham, MD (US)

(72) Inventor: Mark Applegate, Lanham, MD (US)

(21) Appl. No.: 17/747,651

(22) Filed: May 18, 2022

Related U.S. Application Data
(60) Provisional application No. 63/189,994, filed on May 18, 2021.

(51) Int. Cl. B01D 46/00; E03B 3/28; B01D 53/26; B01D 19/00

(52) U.S. Cl. CPC B01D 46/0049; E03B 3/28; B01D 53/265; B01D 19/0063; B01D 2279/50

(57) ABSTRACT

A hydro-enhanced air cleaner is provided as a stand-alone unit or as a component of a heating, ventilation, air conditioning system for a building which cleans and purifies ambient air and is also capable of producing potable water in humid environments. The device includes a dehumidifier which extracts polluted humid air and produces condensate including water and pollutants which adhere to the water. A degasser is connected with the dehumidifier to purify and degas the condensate to produce deionized water and pollutants. A humidifier is connected with the degasser to vaporize at least a portion of the deionized water for delivery to a living space. Excess deionized water may be collected as a potable water supply. In accordance with a method, the apparatus is used to continuously recycle air within a building further continuously clean the air.

This application claims priority of U.S. provisional patent application Ser. No. 63/189,994 filed May 18, 2022.

### BACKGROUND OF THE INVENTION

The U.S. Environmental Protection Agency (EPA) has identified poor Indoor Air Quality (IAQ) as a major contributing factor adversely affecting human health. “Indoor air quality” refers to the quality of the air in a home, school, office, or other building environment. The potential impact of indoor air quality on human health nationally are noteworthy for several reasons:
Americans, on average, spend approximately 90 percent of their time indoors, where the concentrations of some pollutants are often 2 to 5 times higher than typical outdoor concentrations. Currently, more and more people are staying indoors whether working remotely or virtually.
People who are often most susceptible to the adverse effects of pollution (e.g., the very young, students, older adults, people with cardiovascular or respiratory disease) tend to spend even more time indoors.
Indoor concentrations of many pollutants have increased in recent decades due to such factors as energy-efficient building construction (when it lacks sufficient mechanical ventilation to ensure adequate air exchange), heating, ventilation, and air-conditioning (HVAC) systems that typically rely on re-circulation of indoor air (IA) without properly cleaning of this IA, and increased use of synthetic building materials, furnishings, personal care products, pesticides, and household cleaners.
Many industrial facilities use highly hazardous materials in their services that are released within the workplace air without adequate or effective abilities to safely collect and isolate those airborne hazards away from the employees.
Common elevated levels of indoor pollutants such as carbon dioxide (CO₂) have been shown to have detrimental effects on cognitive skills of humans including children and students, professionals, businesspersons, etc. Additional negative impacts of commonly found elevated indoor levels of CO₂ include sleeplessness, anxiety, depression, and more.

Furthermore, many homes have either very expensive water supplies or little to no potable or non-potable water supplies. This leads to many geographical areas with limited possibilities of successful habitation, farming, or most other uses. While in most geographical locations where rainfall, streams, lakes, and/or available underground water sources are scarce or not dependable, there is available water in the air.

Most large buildings have HVAC systems that incorporate air handling units (AHUs) that mostly recirculate the indoor air and, in some cases, introduce outside air (OA). While these AHUs typically provide physical filtration such as high efficiency particulate air (HEPA), each AHU requires many of these HEPA filters to reduce back pressure (or static pressure). Also, these HEPA filters should be replaced annually in order to not damage AHU fan systems with too much static pressure. Moreover, conventional HVAC systems or units are old technology and mostly are not suitable for removing many of the pollutants from the air.

### SUMMARY OF THE INVENTION

The present invention incorporates the latest research and technologies and was developed to provide an innovative, effective and novel solution to unhealthy and polluted indoor air. The concept is that most IA pollutants are intimately and mostly associated with airborne water, or humidity. This system will provide a continuous system of indoor humidity collection as dirty condensate. This dirty condensate will then be cleaned and purified through a dual-pronged process of ultra-filtration and de-gasification. The resulting “cleaned” condensate will then be reintroduced back into the rooms air to attract and collect more Indoor Air pollutants in an ongoing, repeating process to clean the indoor air.

Additionally, this system will be able to collect available humidity from indoor and/or outdoor air in significant quantities to provide a viable source of potable water. This would open many more geographical areas having difficult, expensive or minimal access to rain and/or land-based water sources to successful habitation.

Accordingly, it is a primary object of the invention to provide a method and a hydro-enhanced apparatus for cleaning polluted humid air within a living space including a dehumidifier which extracts polluted humid air from the space and produces condensate including water and pollutants which absorb to the water. A degasser is connected with the dehumidifier to purify and de-gas the condensate to produce deionized water and pollutants. A humidifier is connected with the degasser to vaporize at least a portion of the deionized water for delivery back to the living space.

A filter is preferably arranged at the input to the dehumidifier to remove particulates from the polluted humid air. In addition, a reservoir is provided between the dehumidifier and the degasser to collect condensate from the dehumidifier. Another filter is provided between the reservoir and the degasser to remove at least some of the particulates from the condensate so that partially filtered water is delivered to the degasser.

A controller is connected with the dehumidifier to control the amount of vapor removed from the polluted air, with the degasser to control the volume of degassed air generated by the degasser and with the humidifier to control the humidity of the living space to which deionized water is delivered.

The air cleaning apparatus may be connected with or incorporated into a heating, ventilation and control system for a residence or a commercial or industrial building.

### BRIEF DESCRIPTION OF THE FIGURES

Other objects and advantages of the invention will become apparent from a study of the following specification when viewed in the light of the accompanying drawing, in which:

FIG. 1 is a schematic view of a hydro-enhanced air cleaning apparatus according to a first embodiment of the invention;

FIG. 2 is a schematic view of the apparatus of FIG. 1 incorporated into an HVAC system for a building;

FIGS. 3a and 3b are side and rear schematic views, respectively, of a hydro-enhanced air cleaning apparatus according to an alternate embodiment of the invention;

FIGS. 4a and 4b are side and rear schematic views, respectively, of a high volume water generator according to a further embodiment of the invention;

FIG. 5 is a schematic view of a humidifier which can be connected with the water generator of FIGS. 4a and 4b; and

FIG. 6 is a schematic view of an alternate embodiment of an HVAC system including a modified hydro-enhanced air cleaning apparatus similar to the apparatus of FIGS. 4a and 4b.

### DETAILED DESCRIPTION

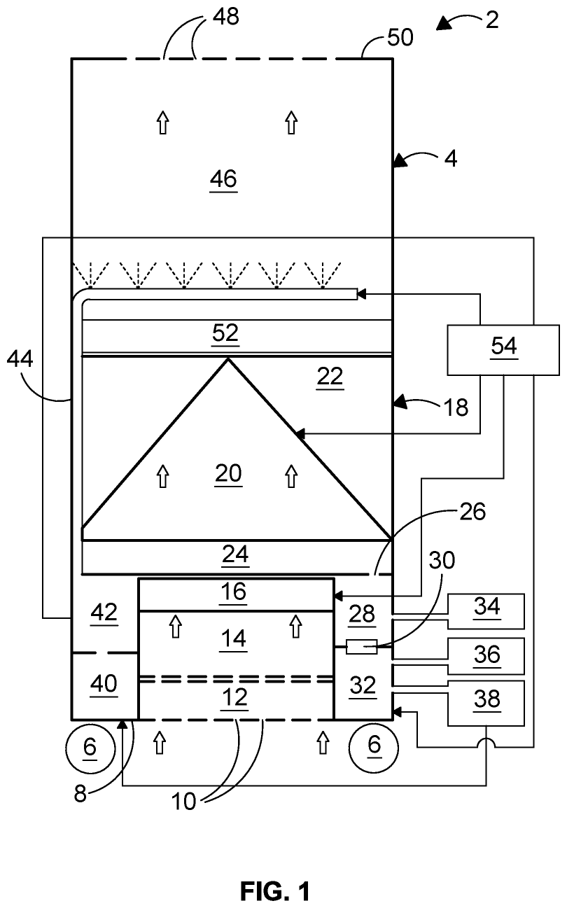

Referring first to FIG. 1, the hydro-enhanced air cleaning device 2 according to a preferred embodiment of the invention will be described. The device includes a housing 4 which is preferably mounted on a plurality of wheels 6 which allow the device to be positioned as a stand-alone unit in a room or other closed space of a building. The device is particularly suitable for use in humid climates with poor air quality. It may be arranged in a residence or in a commercial establishment. While it is shown as being positioned on the floor of the room, the housing could also be mounted on a wall or adjacent to a ceiling.

The bottom wall 8 of the housing contains a plurality of openings 10 through which humid, polluted air may enter the housing. An air filter 12 is arranged adjacent the bottom wall 8 to remove airborne particulates from the polluted air. By way of example only, the air filter may comprise a low MERV filter, i.e. approximately 8 MERV. The particulates are typically of a size that may be inhaled by and collected in the lungs of an individual. Examples of such particulates are biological pollutants including bacteria, molds, viruses, animal dander, cat saliva, dust mites, portions of insects, rodenticides, insecticides, asbestos, heavy metals and smoke. After filtering, the polluted air enters a chamber 14. Preferably, a blower or fan 16 is used to draw the polluted air from outside the housing 4, through the air filter 12, into the chamber 14 and into a dehumidifier 18. Preferably, the dehumidifier includes a plurality of evaporation coils 20 as is known in the art which are arranged in a chamber 22. When the polluted humid air enters the dehumidifier, the evaporation coils aid in converting the humid air into a condensate which includes water and pollutants. A characterizing feature of the invention is that the pollutants adhere to droplets of water which fall within the dehumidifier chamber for collection in a tray 24 at the bottom of the chamber.

The bottom of the collection tray 24 contains an opening 26 through which the condensate passes into a reservoir 28. The outlet of the reservoir contains a filter 30 which removes residual particulates, viruses, bacteria, fungi and the like from the condensate. The filtered water is then delivered to a degas unit or degasser 32, while excess or overflow condensate can be collected via an exhaust 34 for storage, disposal, or recycling through the cleaning apparatus 2. The degasser may be of a membrane, mixed bed resin, freezing or heating type as are known in the art. The degasser operates with or without sonification and under a vacuum. The degasser removes high levels of carbon dioxide, nitrogen dioxide, sulfur dioxide, ozone, hydrogen sulfide, radioactive radon, as well as volatile organic vapors including acetone, toluene, styrene, xylenes, methylene chloride, benzene, ketones, aldehydes, perchloroethylene, and trichloroethylene. These are merely examples of the various gasses that are removed from the condensate by the degasser.

The pollution gasses extracted from the degasser 32 are exhausted for collection in a tank or other receptacle 36 for disposal. The remaining water from the degasser is ionized or pure water which can be bottled as potable water 38 for use by the inhabitants of the building. A portion of the deionized water is delivered to a deionized water reservoir 40 for delivery to a deionized water humidifier 42. The humidifier generates a vapor of deionized water that is delivered via a pipe 44 to a chamber into which the vapor is sprayed via openings in the pipe. The deionized humidified and conditioned air from the chamber is exhausted from the housing 4 via openings 48 in the top wall 50 of the housing. A heater 52 may also be arranged in the chamber to heat the chamber and thus the deionized water vapor therein. In this manner, clean moisture is delivered to a living space in which the air cleaner is arranged to provide a comfortable environment.

The air cleaning device 2 according to the invention includes a controller 54 which is connected with the fan 16, the dehumidifier 18, the degasser 32, the humidifier 42 and the heater 52 to control the operation of each. Appropriate sensors and monitors, not shown, are also provided as is known in the art. With the appropriate settings on the controller, the room or space in which the air cleaner is arranged can be conditioned to the desired humidity and temperature, such as 50% humidity and 70° F.

The deionized water humidity has a strong affinity for absorbing airborne particles. Accordingly, each time an operating cycle is repeated, the ambient air in the space in which the hydro-enhanced air cleaner is arranged will become cleaner, especially in static circumstances. The system can be adjusted to address dynamic pollutant concentration s to maintain an acceptable level of air cleanliness. The apparatus is highly corrosion resistant and able to effectively transfer deionized water into the air with a minimum of contamination. Depending on the humidity in the environment in which the device is arranged, it can provide an ample potable water supply for most houses and buildings.

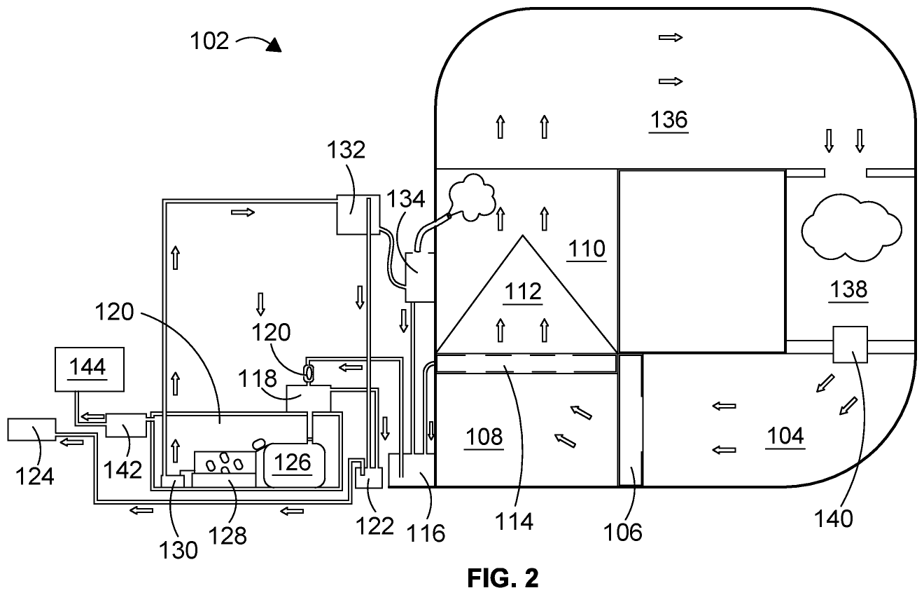

Referring now to FIG. 2, there is shown an air cleaning device incorporated into the heating, ventilation, and air conditioning (HVAC) system 102 of a building. Humid air containing at least some pollutants flows from a chamber 104 through an air filter 106 into a supply chamber 108. The filter removes larger particulars from the air, and the filtered air enters a dehumidifier 110 containing evaporator coils 112 which convert the polluted air into condensate formed of water and pollutants which adhere to the water. The condensate is collected in a tray 114 in the bottom of the dehumidifier.

The condensate is drawn by a pump 116 from the condensate tray and delivered to a dirty water reservoir 118 via a water filter 120 which removes further particulates and other pollutants from the condensate. The bulk of the condensate is delivered to a degasser 120. Excess condensate that overflows the reservoir 118 is drawn by a pump 122 for deliver to an exterior exhaust 124. The degasser removes noxious gasses from the condensate in the same manner as discussed above in connection with the degasser 32 shown in FIG. 1.

However, in the example of FIG. 2, the degasser includes an ice maker 126 which freezes the condensate to form ice cubes which are subsequently heated by a heater 128 to separate the gasses from the water. Deionized water is drawn from the degasser by a pump 130 which delivers the deionized water to a deionized water reservoir 132. A portion of the deionized water is delivered from the reservoir 132 to a steam humidifier 134 which in turn delivers deionized vapor to the dehumidifier 110.

The resulting deionized and conditioned air is delivered via ductwork 136 within the building to one or more living or closed spaces 138 in the building. Any pollutants in the space 138 are attracted to the deionized moisture so that return air from the space carries the pollutants through a return register 140 to the chamber 104 for recycling through the air cleaner system.

Overflow deionized water from the reservoir is drawn by the pump 122 for deliver to the exhaust 124. The noxious gasses extracted from the condensate by the degasser 120 are drawn from the degasser by a pump 142 for delivery to a pollution exhaust 144.

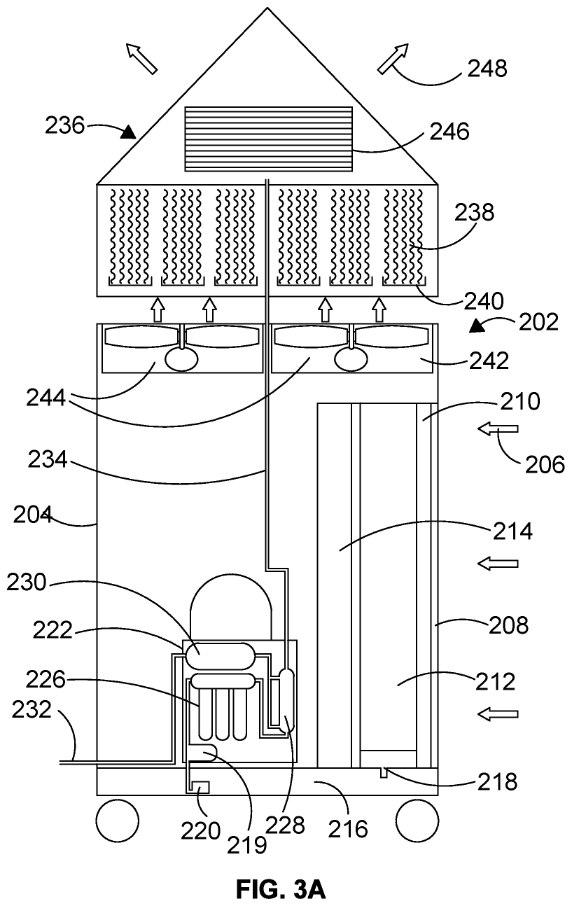

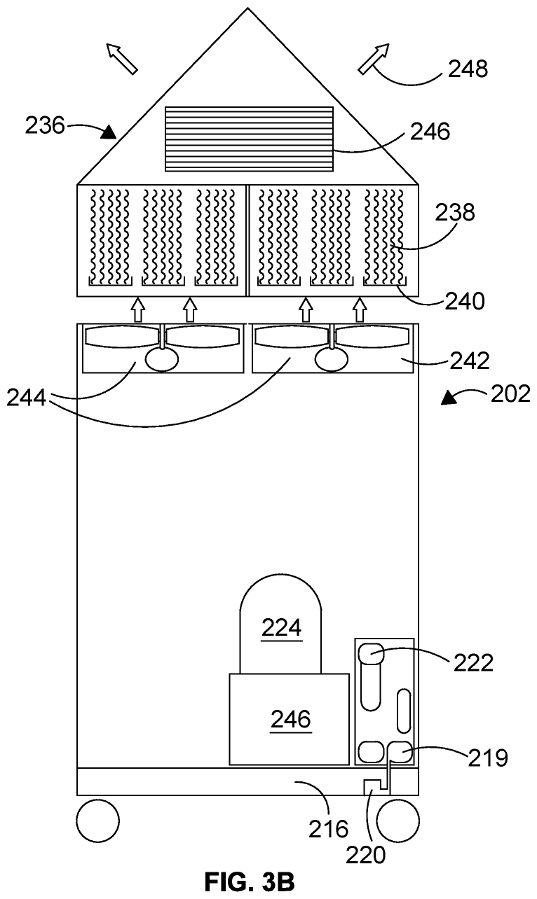

It will be appreciated that the hydro-enhanced air cleaning and water supply generator according to the invention can be designed or engineered in different configurations depending on the environment in which the inventive apparatus is to be used. An alternate embodiment for the stand-alone assembly of FIG. 1 is shown in FIGS. 3a and 3b.

The stand-along assembly 202 includes a housing 204. Ambient air represented by arrows 206 enters the housing 204 via downwardly directed louvers 208 and flows through a filter 210, evaporator coils 212 and condenser coils 214 which serve as a dehumidifier. Dirty condensate from the coils is collected in a dirty condensate reservoir 216 via a drain 218. Dirty condensate from the reservoir is drawn from the reservoir 216 by a pump 219 via a valve 220. The dirty condensate is delivered to a condensate treatment module 222 having a compressor 224 connected therewith. The condensate treatment module includes an ultra-filtration water filter system 226 and a contactor de-gasser 228. The de-gasser separates polluted gas from the dirty condensate which is drawn by a vacuum pump 230 from the de-gasser 228 and exhausts it from the housing via an exhaust outlet 232 where the polluted gas may be captured. Filtered, de-gassed clean water is delivered from the de-gasser via a pipe 234 which exits the top of the housing. Clean air from the housing 204 is drawn through a filter 242 via an exhaust fan system 244 and exits the top of the housing. A controller 246 is provided to control the operation of the various components of the stand-alone system.

If desired, a humidifier 236 may be connected with the top of the housing 204. De-gassed clean water is delivered to the top of the humidifier from the pipe 234. Clean air is delivered to the humidifier from the exhaust fan system 244. The humidifier includes desorption membranes 238. A reservoir 240 in the bottom of the humidifier collects excess water. Humidified clean air exits the humidifier via louvers 246 as shown by the arrows 248.

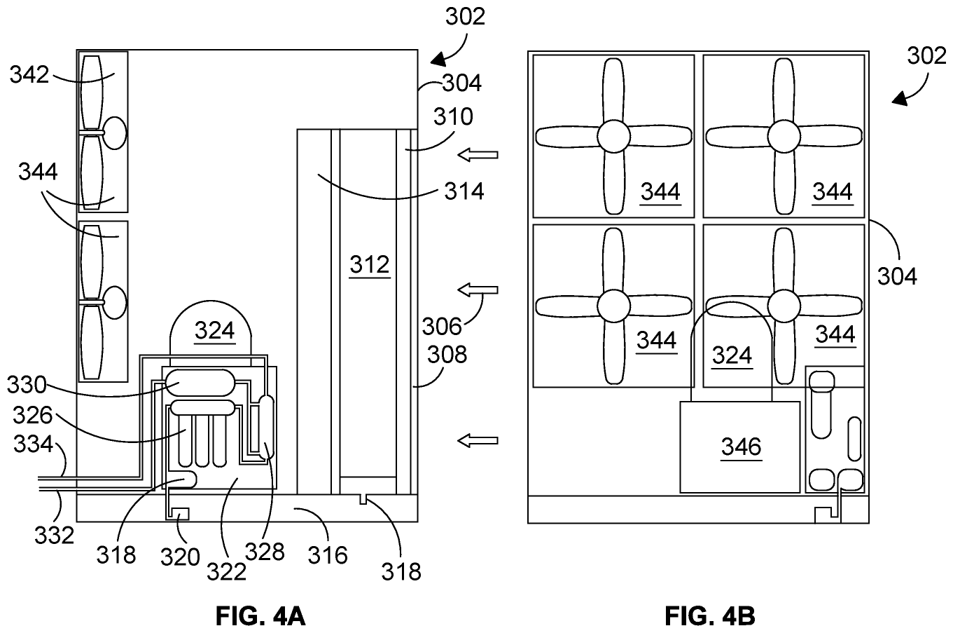

An alternate configuration for the stand-alone assembly of FIGS. 3a and 3b is shown in FIGS. 4a and 4b. As shown therein, the stand-along assembly 302 includes a housing 304. Ambient air represented by arrows 306 enters the housing 304 via downwardly directed louvers 308 and flows through a filter 310, evaporator coils 312 and condenser coils 314 which act as a dehumidifier. Dirty condensate from the coils is collected in a dirty condensate reservoir 316 via a drain 318. Dirty condensate from the reservoir is drawn from the reservoir 316 by a pump 318 via a valve 320. The dirty condensate is delivered to a condensate treatment module 322 having a compressor 324 connected therewith. The condensate treatment module includes an ultra-filtration water filter system 326 and a contactor de-gasser 328. The de-gasser separates polluted gas from the dirty condensate which is drawn by a vacuum pump 330 from the de-gasser 328 and exhausts it from the housing via an exhaust outlet 332 where the polluted gas may be captured. Filtered, de-gassed clean water is delivered from the de-gasser via a pipe 334 to the exterior of the housing. Clean air from the housing 304 is drawn through a filter 342 via an exhaust fan system 344. A controller 346 is provided to control the operation of the various components of the stand-along system.

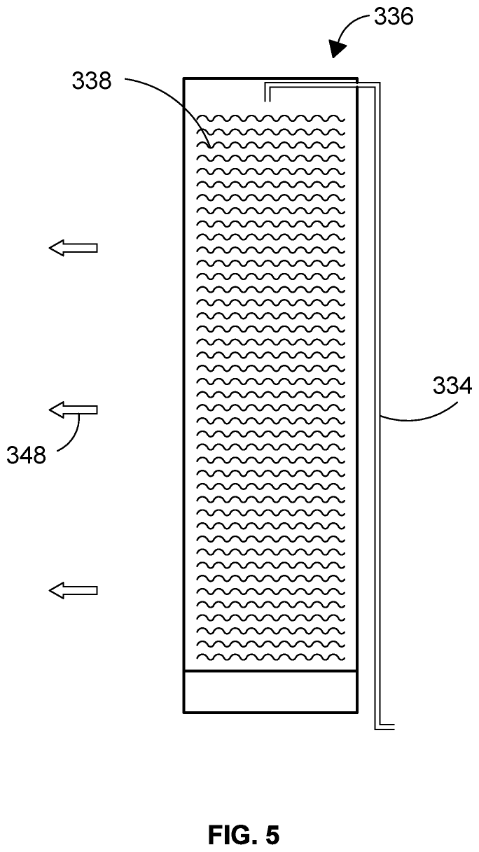

If desired, a humidifier 336 as shown in FIG. 5. may be connected with the rear of the housing 304 adjacent to the exhaust fan system. De-gassed clean water is delivered to the top of the humidifier from the pipe 334. Clean air is delivered to the side of the humidifier from the exhaust fan system 344. The humidifier includes desorption membranes 338. A reservoir 340 in the bottom of the humidifier collects excess water. Humidified clean air exits the side of the humidifier as shown by the arrows 348.

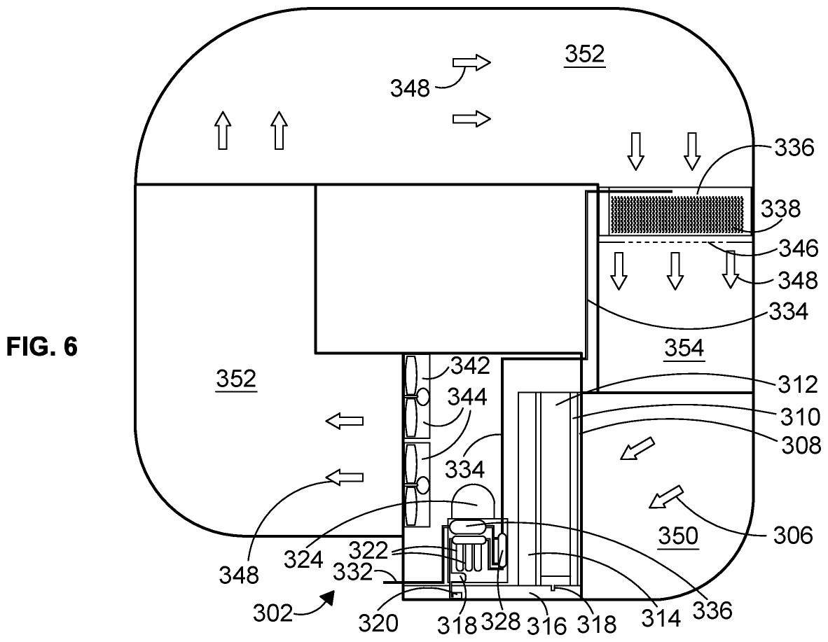

Referring now to FIG. 6, the installation of the side discharge air cleaning and water supply assembly within an HVAC system for a building will be described. The components of the system are shown with the same reference numbers as shown in FIGS. 4a, 4b, and 6 and thus a description of these components will not be repeated here.

The assembly 302 mounted within the duct work system of the building. More particularly, air from an air return duct 350 of the HVAC system serves as the input air supply 306 for the assembly 302. The clean air exhaust 348 from the assembly is delivered to supply ducts 352 of the HVAC system. The supply ducts deliver the clean air to a register in each room of the building. If desired, a humidifier 336 may be provided within the duct system to add moisture to the air supply. While the humidifier is shown as being arranged within the supply duct 352 to a room 354, it will be appreciated that the humidifier may be arranged at any location within the HVAC system. In addition, multiple humidifiers may be arranged in the system, each of which is supplied with water from the air cleaning and water supply assembly via a water exhaust pipe 334.

While the preferred forms and embodiments of the invention have been illustrated and described, it will become apparent to those of ordinary skill in the art that various changes and modifications may be made without deviating from the inventive concepts set forth above.

1-14. (canceled)

15. Apparatus for cleaning polluted humid air, comprising
(a) a dehumidifier which extracts the polluted humid air and produces condensate including water and pollutants which adhere to the water;
(b) a degasser connected with said dehumidifier which purifies and degasses the condensate to produce deionized water and pollutants; and
(c) a humidifier connected with said degasser which vaporizes at least a portion of the deionized water for delivery to a living space.

16. Apparatus as defined in claim 15, and further comprising an air filter connected with an input of said dehumidifier to remove particulates from the polluted humid air.

17. Apparatus as defined in claim 16, wherein said dehumidifier includes a blower which draws filtered air from said air filter for delivery to said dehumidifier input.

18. Apparatus as defined in claim 16, and further comprising a reservoir between said dehumidifier and said degasser for collecting the condensate.

19. Apparatus as defined in claim 18, and further comprising a filter for removing at least some of the pollutants from the condensate for delivery of at least partially filtered water to said degasser.

20. Apparatus as defined in claim 15, and further comprising a reservoir connected with said degasser for collecting at least a portion of said deionized water as potable water.

21. Apparatus as defined in claim 15, and further comprising a controller connected with said dehumidifier to control the amount of vapor removed from polluted humid air.

22. Apparatus as defined in claim 21, wherein said controller is connected with said degasser to control the volume of degassed air generated by said degasser.

23. Apparatus as defined in claim 22, and further comprising a heater which heats air in the living space, wherein said controller is connected with said humidifier to control the humidity of the living space to which the deionized water is delivered and with said heater to control the temperature of the air in the living space.

24. Apparatus as defined in claim 15, wherein said pollutants include airborne particulates and biological pollutants.

25. Apparatus as defined in claim 15, wherein said degasser removes at least one of nitrous oxide, sulfur dioxide, carbon dioxide, ozone, hydrogen sulfide and radon.

26. A heating, ventilation and control system for a living space including an apparatus for cleaning polluted humid air, comprising
(a) a dehumidifier which extracts the polluted humid air and produces condensate including water and pollutants which adhere to the water;
(b) a degasser connected with said dehumidifier which purifies and degasses the condensate to produce deionized water and pollutants; and
(c) a humidifier connected with said degasser which vaporizes at least a portion of the deionized water for delivery to the living space.

27. A method for cleaning air in a polluted humid environment, comprising the steps of
(a) dehumidifying the air to produce condensate including water having pollutants adhered thereto;
(b) degassing the condensate to produce deionized water and gaseous pollutants; and
(c) humidifying the air in a living space with the deionized water.

28. The method as defined in claim 27, and further comprising the steps of filtering particulates from the air prior to said dehumidifying step.

29. The method as defined in claim 28, and further comprising the step of filtering at least some of the pollutants from the condensate.

30. The method as defined in claim 29, wherein said degassing step comprises removing at least one of nitrous oxide, sulfur dioxide, carbon dioxide, ozone, hydrogen sulfide and radon.

31. The method as defined in claim 30, and further comprising the steps of controlling the amount of vapor removed from polluted humid air, controlling the volume of degassed air generated by said degassing step, controlling the humidity of the living space to which the deionized water is delivered, and controlling the heat of the air of the living space.
